(19) United States
(12) Patent Application Publication
(10) Pub. No.: US 2019/0197307 A1
(43) Pub. Date: Jun. 27, 2019

(54) UPDATING DATA SETS ON GRAPHICAL USER INTERFACES BASED ON INPUTS FROM ELECTRONIC DOCUMENTS

(71) Applicant: GOOGLE LLC, Mountain View, CA (US)

(72) Inventors: Shih-Hao Yeh, Santa Clara, CA (US); Navid Samadani-McQuirk, San Bruno, CA (US); Joshua Curtis Hudgins, Niwot, CO (US); Jack Cameron Dille, San Francisco, CA (US)

(21) Appl. No.: 16/132,188

(22) Filed: Sep. 14, 2018

Related U.S. Application Data
(60) Provisional application No. 62/610,030, filed on Dec. 22, 2017.

(51) Int. Cl. G06K 9/00; G06F 3/0482; G06K 9/62

(52) U.S. Cl. CPC G06K 9/00463; G06Q 30/0223; G06K 9/6201; G06F 3/0482

(57) ABSTRACT

Modifying graphical user interfaces based on new data obtained from electronic documents comprises a computing system and an image capturing system of a user. The computing device receives a first digital image comprising a first set of data and extracts the first set of data from the first digital image. The computing device populates a list with a first set of data. The computing device receives a second digital image comprising a second set of data and extracts the second set of data from the second digital image. The computing device then modifies the list based on the second set of data. The computing device searches for third party data to associate with items on the list and takes appropriate action based on the association.

### CROSS-REFERENCE TO RELATED APPLICATION

This patent application claims priority to U.S. Provisional Patent Application No. 62/610,030, filed Dec. 22, 2017 and entitled “Updating Data Sets on Graphical User Interfaces Based on Inputs from Electronic Documents.” The entire contents of the above-identified application are hereby fully incorporated herein by reference.

### TECHNICAL FIELD

The technology disclosed herein relates to modifying graphical user interfaces, and more particularly to updating the data sets based on new data that is obtained from electronic documents, such as images and messages.

### BACKGROUND

Users often create simple, generic lists that comprise a list items, such as items on a shopping list or a to-do list. To create or modify such conventional lists, users must manually input each item on the list and then manually remove or otherwise modify each item on the list. For example, to create a shopping list, a user must manually type the name of each item on the list, and the list may include five, fifteen, twenty-five, or even 100 or more items. Then, after obtaining the items on the list, or after obtaining each individual item on the list, the user must manually check-off, strike through, delete, or otherwise remove each obtained item from the list. Such inputs are time-consuming and cumbersome and generally cause users to avoid electronic lists.

### SUMMARY

Techniques herein provide computer-implemented methods to modify graphical user interfaces based on new data obtained from electronic documents. The method comprises a computing device that receives a first digital image comprising a first set of data and extracts the first set of data from the first digital image. The computing device populates a list with a first set of data. The computing device receives a second digital image comprising a second set of data and extracts the second set of data from the second digital image. The computing device then modifies the list based on the second set of data.

In certain other example aspects described herein, systems and computer program products to render graphical user interfaces to modify graphical user interfaces based on new data obtained from electronic documents.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to render graphical user interfaces to create and modify lists of items based on items identified in electronic documents, in accordance with certain examples.

FIG. 2 is a block flow diagram depicting a method to render graphical user interfaces to create and modify lists of items based on items identified in electronic documents, in accordance with certain examples.

FIG. 3 is a block flow diagram depicting a method to register for an account with a management computing system and to download an application onto a user computing device, in accordance with certain examples.

FIG. 4 is a block flow diagram depicting a method to generate a list of items, in accordance with certain examples.

FIG. 5 is a block flow diagram depicting a method to associate offers with the generated list of items, in accordance with certain examples.

FIG. 6 is a block flow diagram depicting a method to create and modify lists of items based on items identified in electronic documents, in accordance with certain examples.

FIG. 7 is a block flow diagram depicting a method to receive an electronic image, in accordance with certain examples.

FIG. 8 is a block flow diagram depicting a method to extract items from electronic documents, in accordance with certain examples.

FIG. 9 is a block flow diagram depicting a method to determine a receipt type based on an electronic image of a receipt, in accordance with certain examples.

FIG. 10 is a block flow diagram depicting a method to redeem a stored offer based on receipt data, in accordance with certain examples.

FIG. 11 is an illustration of a graphical user interface comprising an empty list, in accordance with certain examples.

FIG. 12A is an illustration of a hand-written list on paper, in accordance with certain examples.

FIG. 12B is an illustration of a paper receipt comprising a list of items, in accordance with certain examples.

FIG. 13 is an illustration of a graphical user interface comprising a list of items created based on items identified in an electronic document and indicating an associated offer, in accordance with certain examples.

FIG. 14 is an illustration of another electronic document comprising a list of items in a receipt, in accordance with certain examples.

FIG. 15 is an illustration of a graphical user interface comprising a list of items modified based on items identified in an electronic document, in accordance with certain examples.

FIG. 16 is a block diagram depicting a computing machine and a module, in accordance with certain examples.

### DETAILED DESCRIPTION

### Overview

Embodiments herein provide computer-implemented techniques for updating data sets based on new data that is obtained from electronic documents.

In an example, a user registers with a product management computing system and downloads a list application, such as a shopping list application, by accessing a product management computing system website via a user computing device, registering for a user account, entering account information, and downloading the application onto the user computing device. The user requests to generate a new list of items, such as a shopping list, via the application or requests to retrieve a previous list of items. The product management computing system receives the request and retrieves the previous list of items or generates a new list of items in accordance with the request. The product management computing system transmits the previous user generated list of items or a display that allows the user to create a new user generated list of items to the user computing device for display via the user computing device. For example, a new user generated list of items comprises a blank list to which the user may add desired items. The user computing device displays the received user generated list of items, and the user edits the displayed list of items. Editing the user generated list of items may comprise adding one or more items, deleting one or more items, and/or modifying a quantity associated with one or more items on the list of items. The user may select from preexisting item descriptions, enter text or photos of items, and/or speak a voice command to add items to the user generated list of items. In an example, the user selects a user interface element add an item to the list or a user interface element to modify items on the list.

The product management computing system searches for third party data, such as offers, from merchant systems, third party systems, and previously stored offers. The third party data may be any suitable type of offer, such as a rebate, a discount, a “buy 1 get 1 free” offer, a loyalty points offer, or any other type of offer. The product management computing system compares offers with items on the shopping list. In an example, when an offer is identified, such as on a database of a merchant computing system, the offer is compared to the items on the shopping list to determine if the offer is associated with items that the user has purchased before, included on the shopping list currently or in the past, or is currently recommended to the user.

The product management computing system provides an opportunity to the user to add the item and the associated offer to the shopping list and associate the offer with a particular item. For example, the product management computing system provides an interface object that adds the item to the shopping list when actuated by the user.

To add items to a list, the user may take a picture, scan, or otherwise capture an electronic image of a paper document, such as a list or receipt. The system analyzes the electronic image to identify items on the document and displays each item on the shopping list. To modify an existing list, the user may take a picture, scan, or otherwise capture an electronic image of a paper document, such as a list or receipt. The system analyzes the electronic image to identify items on the document, determines which items on the document are also on the existing list, flags each co-existing item, and displays an updated list with an indication that the co-existing items have been obtained. The indication may include a check mark by the item, strike-through of the item, removing the item from the list, moving the item to a separate section of the list for obtained items, combinations of the foregoing, and any other suitable indication of that the item on the existing list is removed from the updated list.

The system identifies offers that match items on the existing list. The system notifies the user of offer for an item that is not currently on the shopping list and provides an opportunity to add item to the shopping list. For example, the system recognizes an offer for a product that the user has had on the shopping list in the past, but is not currently on the shopping list. The system stores the matching offers and associates the offers with the matching items on the shopping list. When an offer is determined to match an item, the offer is stored with the item. For example, the offer is displayed next to the item on the graphical display of the shopping list. The offer is associated with the item by storing instructions to access the offer when the item is accessed.

The system compares purchased items identified in the receipt to the stored offers in the shopping list. When the system extracts data from the receipt, the system identifies items from the shopping list that have been updated to indicate the items are purchased based on the receipt data. The system determines if the purchase meets the requirements of the stored offer. The system identifies the characteristics of the purchase transaction, such as the date and time of the transaction, the exact model number of the item, the merchant system that sold the item, price paid for the item, or any other transaction characteristics.

The system compares the available extracted data to the requirements of the offer. For example, the offer may require that a purchase be made before a certain expiration date. The system may compare the date of the transaction that is extracted from the receipt to the expiration date of the offer. Further, the system uses the image of the receipt as a proof of purchase or other evidence to support the redemption of the offer.

If the purchase meets the requirements of the offer, then the transaction is determined to qualify for the offer. The system redeems the offer by submitting the transaction to the offer provider for redemption. In an example, the offer is a rebate of $5 when the transaction is over $50. If the terms of the offer are met, then the system submits the details of the transaction to the offer provider. If the offer provider approves the rebate, then the offer provider may transmit $5 to the user by sending funds to the user in any other suitable manner. If the offer provider determines that the transaction does not meet the terms of the offer, then the rebate is refused. In another example, the offer provider may provide a quantity of loyalty points or rewards to the user based on the terms of the offer. The system indicates on the shopping list that an offer has been redeemed for the item on the shopping list.

By using and relying on the methods and systems described herein, the system intelligently matches offers to shopping list items to allow users to redeem coupons by capturing an image of a receipt. As such, the systems and methods described herein may be employed to simplify offer redemption for users. By automatically searching for and finding offers matched to shopping list items, users receive the benefit of offers without having to find them and determine if the offers match the items that the user intends to purchase. The system further automatically redeems the offers based on the data and the proof provided in the receipt image, saving the user the steps of manually redeeming the offers.

Various examples will be explained in more detail in the following description, read in conjunction with the figures illustrating the program flow.

Turning now to the drawings, in which like numerals represent like (but not necessarily identical) elements throughout the figures, example embodiments are described in detail.

### Example System Architectures

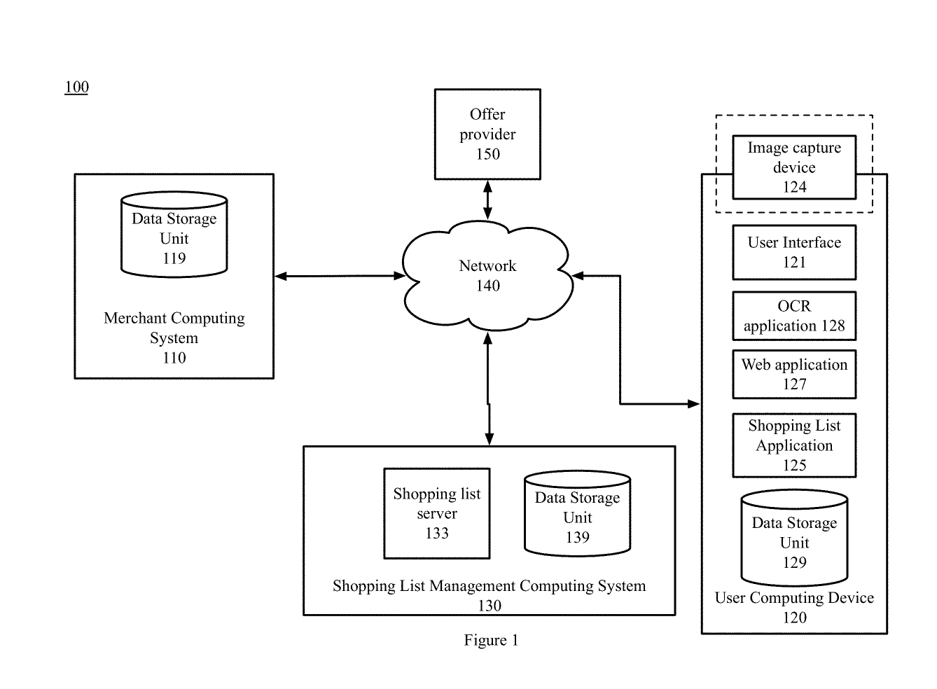

FIG. 1 is a block diagram depicting a system to render graphical user interfaces to create and modify lists of items based on items identified in electronic documents, in accordance with certain examples. As depicted in FIG. 1, the example operating environment 100 comprises systems 110, 120, 130, and 150 that are configured to communicate with one another via one or more networks 140 via network computing devices. Two or more of these systems (including systems 110, 120, 130, and 150) may be integrated into the same system. In some examples, a user associated with a device must install an application and/or make a feature selection to obtain the benefits of the techniques described herein.

Each network 140 comprises a wired or wireless telecommunication mechanism by which network systems (including systems 110, 120, 130, and 150) can communicate and exchange data. For example, each network 140 can include, be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, Bluetooth Low Energy (BLE), near field communication network (NFC), any form of standardized radio frequency, infrared, sound (for example, audible sounds, melodies, and ultrasound), other short range communication channel, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example, each network system (including systems 110, 120, 130, and 150) comprises a device having a communication module capable of transmitting and receiving data over the network 140. For example, each network system (including systems 110, 120, 130, and 150) may comprise a server, personal computer, mobile device (for example, notebook computer, handheld computer, tablet computer, netbook computer, personal digital assistant (PDA), video game device, GPS locator device, cellular telephone, Smartphone, or other mobile device), a television with one or more processors embedded therein and/or coupled thereto, an appliance with one or more processors embedded therein and/or coupled thereto, or other appropriate technology that comprises or is coupled to a web browser or other application for communicating via the network 140. In the example depicted in FIG. 1, the network systems (including systems 110, 120, 130, and 150) are operated by merchant computing system operators, users, shopping list management computing system operators, and offer provider operators respectively.

An example user computing device 120 comprises a user interface 121, a shopping list application 125, and a data storage unit 129. In an example, the user computing device 120 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that comprises or is coupled to a web server (or other suitable application for interacting with web page files) or that comprises or is coupled to the application 125.

A user interface 121 comprises a touch screen, a voice-based interface, or any other interface that allows the user to provide input and receive output from the application 125. In an example, the user interacts with the application 125 via the user interface 121. The user can use the user computing device 120 to generate a new shopping list, access a previous shopping list, or modify a previous shopping list via a user interface 121 and the application 125. The user can edit a shopping list via the shopping list application 125 and can request product recommendations to correspond to each item in the shopping list. The user interface 121 may present a graphical user interface displaying a shopping list and various functions available for the shopping list, and may receive inputs from other peripheral devices (not depicted in FIG. 1).

The shopping list application 125 is a program, function, routine, applet, or similar entity that exists on and performs its operations on the user computing device 120. For example, the application 125 may be one or more of a shopping application, a search application, an Internet browser, a digital wallet application, a loyalty card application, another value-added application, a user interface 121 application, or other suitable application operating on the user computing device 120. In some examples, the user must install an application 125 and/or make a feature selection on the user computing device 120 to obtain the benefits of the techniques described herein.

In an example, the user can use a communication application, such as a web browser application 127 or shopping list application 125, to view, download, upload, or otherwise access documents or web pages via the distributed network 140. In certain examples, one or more functions described herein as performed by the shopping list application 125 may be performed by the web browser application 127. In certain examples, one or more functions described herein as performed by the web browser application 127 may be performed by the shopping list application 125.

The data storage unit 129 enables storage of user account details for retrieval by a user shopping list management computing system 120 account and/or storage of shopping list data. The data storage unit 129 may include any local or remote data storage structure accessible to the user computing device 120 suitable for storing information. The data storage unit 129 may store encrypted information, such as HTML5 local storage.

An image capture device 124 obtains electronic images of paper documents and communicates the electronic images to the shopping list application 125 and/or an optical character recognition (OCR) application 128. The image capture device 124 may be a camera, scanner, or other device suitable to obtain electronic images of paper documents. The image capture device 124 may be an integral component of the user computing device 120 or may be an external device in communication with the user computing device 120.

The optical character recognition (OCR) application 128 receives the electronic images from the image capture device 124 or the shopping list application 125, processes the images to identify products from documents represented in the electronic images, and communicates the identified products to the shopping list application 125.

To create a new list, the shopping list application 125 receives the identified products and renders a graphical user interface 121 comprising a list of the identified products. To modify an existing list, the shopping list application receives the identified products, determines which of the identified products are already listed on the existing list, and modifies the user interface 121 to check-off the identified products on the existing list or to otherwise indicate the identified products have been obtained or are no longer needed on the list.

The user computing device 120 communicates with the shopping list management computing system 130 via the network 140. The shopping list management computing system 130 comprises a shopping list server 133 and a data storage unit 129. User generated shopping lists are saved in the data storage unit 139. Additionally, one or more functions described herein as performed by the shopping list application 125 and/or the OCR application 128 may be performed by the shopping list server 133. The shopping list management computing system 130 also manages user accounts associated with shopping lists.

The data storage unit 139 can include any local or remote data storage structure accessible to the shopping list management computing system 130 suitable for storing information. The data storage unit 139 may store encrypted information, such as HTML5 local storage.

The merchant computing system 110 may represent any seller of products or services, including manufacturers, retail stores, online stores, distributors, or any other type of merchant. The merchant computing system 110 may provide offers for purchases, such as rebates, discounts, loyalty points, or any other type of offer. The merchant computing system 110 may store databases of offers for searching or the merchant computing system 110 may redeem offers provided by other offer providers 150.

The data storage unit 119 can include any local or remote data storage structure accessible to the merchant computing system 110 suitable for storing information. The data storage unit 119 may store encrypted information, such as HTML5 local storage.

The offer provider 150 represents any party that prepares, supplies, distributes, redeems, or publishes offers for redemption. The offer provider 150 may work in conjunction with a merchant computing system 110 to provide offers. For example, the offer provider 150 distributes offers that may be redeemed at the merchant computing system 110.

It will be appreciated that the network connections shown are example and other means of establishing a communications link between the computers and devices can be used. Additionally, those having ordinary skill in the art and having the benefit of the present disclosure will appreciate that the computing devices illustrated in FIG. 1 can have any of several other suitable computer system configurations. For example a user computing device 120 embodied as a mobile phone or handheld computer may not include all the components described above.

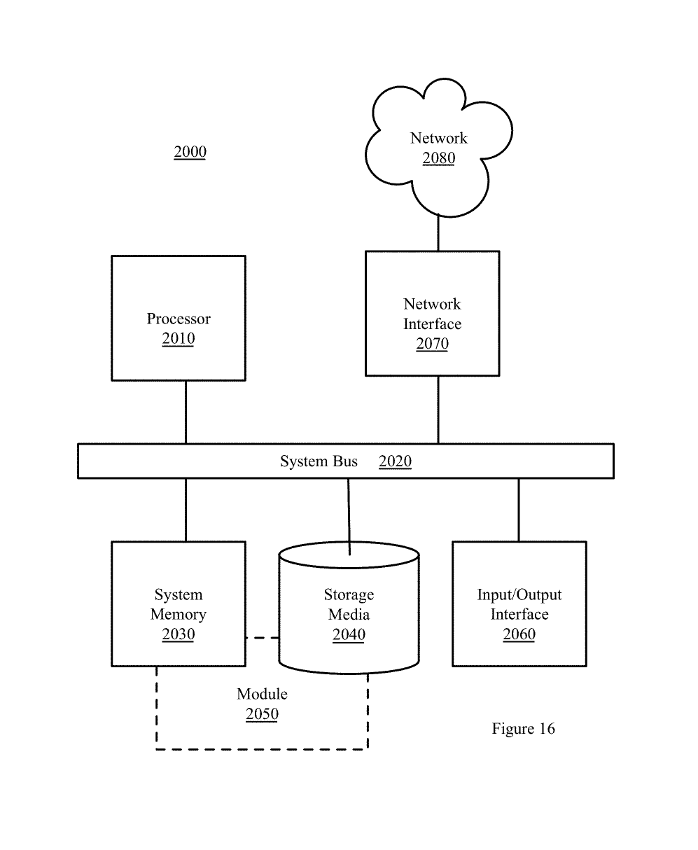

The network computing devices and any other computing machines associated with the technology presented herein may be any type of computing machine such as, but not limited to, those discussed in more detail with respect to FIG. 16. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 16. The computing machines discussed herein may communicate with one another, as well as with other computing machines or communication systems over one or more networks, such as network 140. The network 140 may comprise any type of data or communications network, including any of the network technology discussed with respect to FIG. 16.

### Example Processes

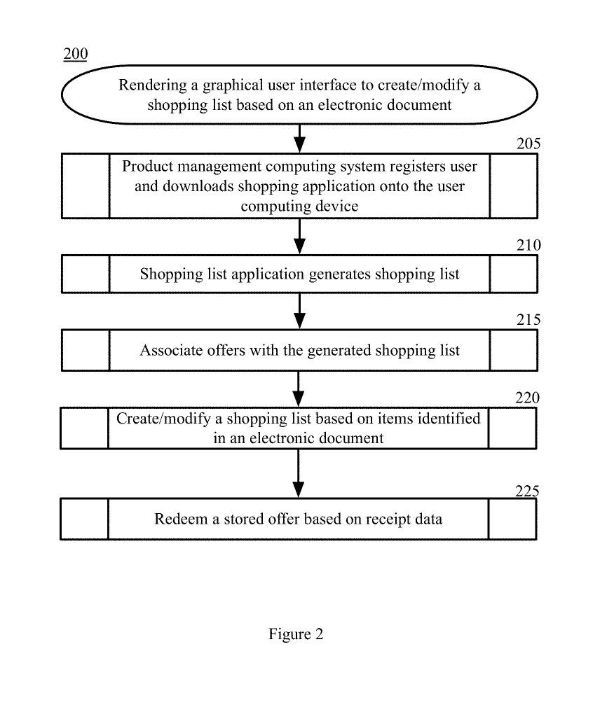

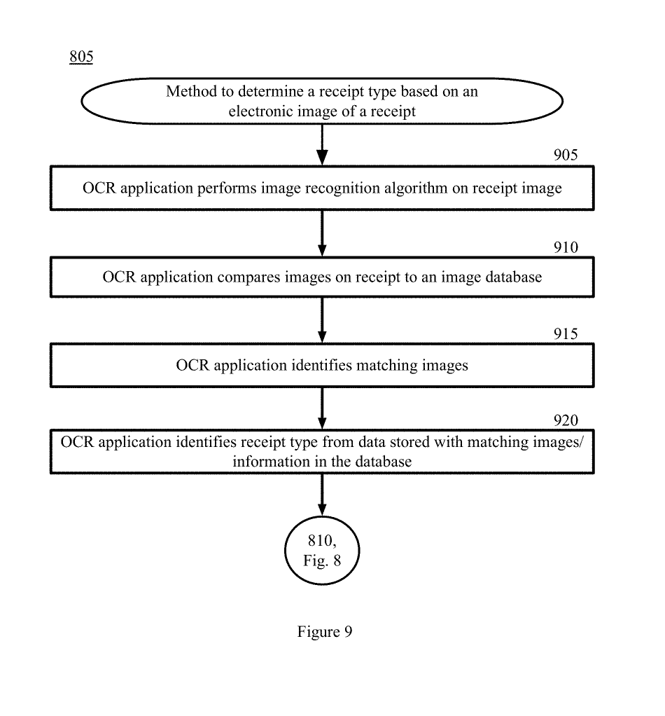

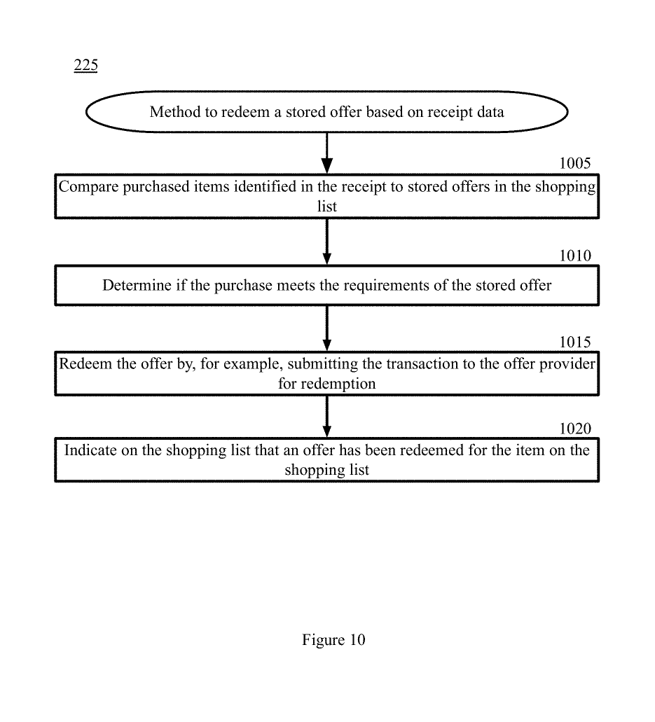

The components of the example operating environment 100 are described hereinafter with reference to the example methods illustrated in FIGS. 2-8 and with reference to the illustrations in FIG. 9-13. The example methods of FIGS. 2-8 may also be performed with other systems and in other environments.

The operations described with respect to any of the FIGS. 2-8 can be implemented as executable code stored on a computer or machine readable non-transitory tangible storage medium (e.g., floppy disk, hard disk, ROM, EEPROM, nonvolatile RAM, CD-ROM, flash memory, other memory, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block flow diagram depicting a method to render graphical user interfaces to create and modify lists of items based on items identified in electronic documents, in accordance with certain examples. The method 200 is described with reference to the components illustrated in FIG. 1.

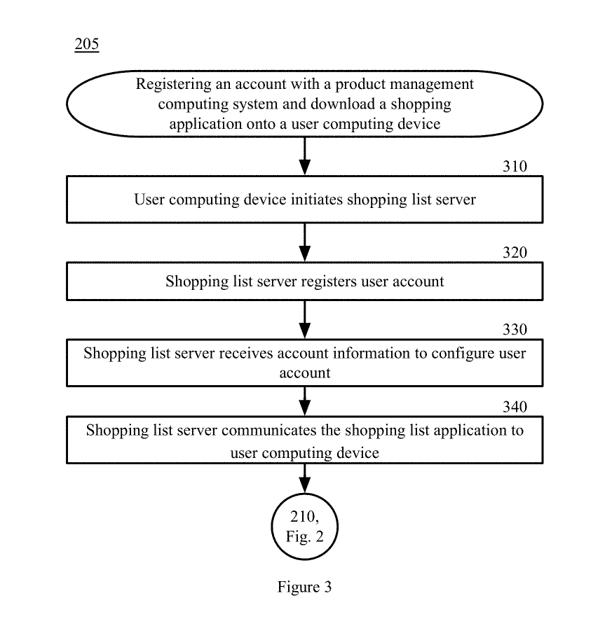

In block 205, a user registers with the shopping list management computing system 130 and downloads a shopping list application 125 onto the user computing device 120. The method to register with the shopping list management computing system 130 and to download a shopping list application 125 onto the user computing device 120 is described in more detail hereinafter with reference to the methods described in FIG. 3.

FIG. 3 is a block flow diagram depicting a method 205 to register an account with a shopping list management computing system 130 and to communicate a shopping list application 125 to a user computing device 120, in accordance with certain examples, as referenced in block 205 of FIG. 2. The method 205 is described with reference to the components illustrated in FIG. 1.

In block 310, the user computing device 120 initiates the shopping list server 133 (or an operating system application store). The user enters a website address into the web browser application 127 or otherwise accesses the website (or application store) over the network 140 via the user interface 121 of the user computing device 120. The user may also access a platform, digital distribution service, or distribution application over the network 140 via the user computing device 120 to access the shopping list application 125.

In block 320, the shopping list server 133 registers the user account. In another example, the user registers for a user account via the platform, digital distribution service, or distribution application. The user may obtain a user account number, receive the appropriate applications and software to install on the user computing device 120, or perform any action required by the shopping list management computing system 130. The user may utilize the functions of the user computing device 120, such as the user interface 121 and a web browser or other application, to register and configure a user account. The shopping list server 133 receives the data from the user computing device 120 and registers the user account.

In block 330, the shopping list server 133 receives account information to configure the user account. Certain account settings may be configurable by the user to communicate to the shopping list server 133. In addition to user contact information and configurable authentication settings, the user may add, delete, or edit payment account information via the shopping list server or via the platform, digital distribution service, or distribution application. In an example, the user may select an option to enable or disable the permission of the product management computing system to process transactions. The payment account information may comprise an account number, an expiration date, an address, a user account holder name, or other information associated with the user payment account that would enable the shopping list management computing system 130 to process a payment transaction. The user may define user preferences that the shopping list management computing system 130 can use to produce shopping lists, including product recommendations related to items on the list. Certain user preferences comprise favorite products, favorite brands, favorite merchants, or a combination of a favorite product, a favorite brand, and/or a favorite merchant. For example, user preferences may comprise Merchant A, Brand Z potato chips, and Brand M candles sold at Merchant Z. The shopping list management computing system 130 deduces user preferences based on user selection and viewing histories.

In block 340, the shopping list server 133 communicates the shopping list application 125 to the user computing device 120 for downloading to the user computing device 120. The user may select an option on the product management computing system server 133 to download the shopping list application 125 onto the user computing device 120. Depending on the operation of the shopping list application, the user may register for an account and upload account information prior to downloading the shopping list application 125. Alternatively, the user may first download the shopping list application 125 and then register for an account and upload account information via the shopping list application 125.

From block 340, the method 205 proceeds to block 210 in FIG. 2.

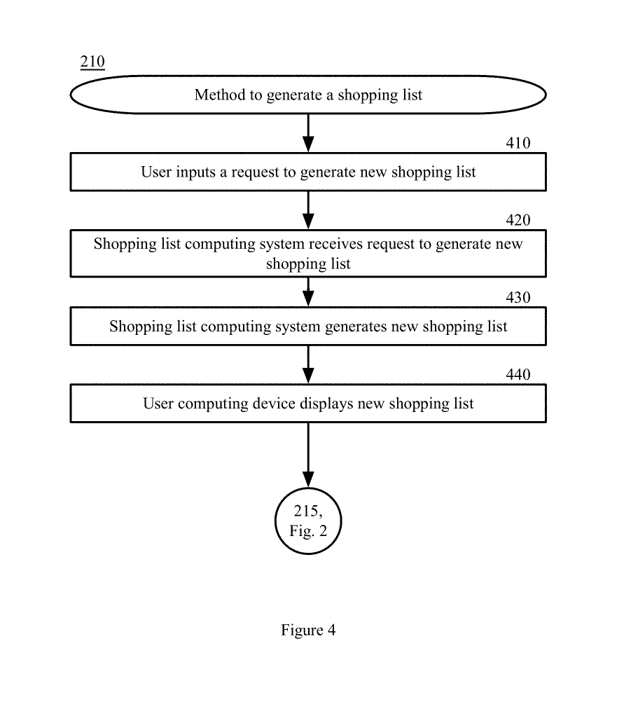

Returning to FIG. 2, in block 210, the shopping list application 125 generates a shopping list. The method to generate a shopping list is described in more detail hereinafter with reference to the methods described in FIG. 4.

FIG. 4 is a block flow diagram depicting a method 210 to generate a shopping list of items, in accordance with certain examples, as referenced in block 210 of FIG. 2. The method 210 is described with reference to the components illustrated in FIG. 1.

In block 410, the user inputs a requests to generate a new shopping list. For example, the user signs into the shopping list application 125 on the user computing device 120 and selects a user interface 121 object to request to generate a new shopping list. For example, the user interface 121 object reads “generate new shopping list.” In another example, the user requests to access a previous shopping list previously generated by the user. For example, the user signs into the shopping list application 125 on the user computing device 120 and selects a user interface 121 object to request to access a previous user generated shopping list. For example, the user interface 121 object reads “access saved shopping list.”

In an example, a shopping list comprises a listing of one or more terms entered by or on behalf of the user. The listing of terms may comprise generalized terms describing one or more items desired by the user. The generalized terms comprise an item description or broad category that corresponds to a shopping list item. For example, the generalized term is “milk” instead of the specific terms “Brand A Organic Skim Milk.” For certain items on the list, the listing of terms comprises specific terms entered by or on behalf of the user. In this example, the user enters or the shopping list management computing system 130 determines the specific terms corresponding to the user's desired item.

In block 420, the shopping list management computing system 130 receives the request to generate the new shopping list. For example, in response to receiving an input of a selection of the user interface 121 object, the user computing device 120 transmits a request to generate a new shopping list to the shopping list management computing system 130 via the network 140. In this example, the shopping list management computing system 130 receives the request to generate the new shopping list via the network 140. In another example, the shopping list management computing system 120 receives the request to access the previous shopping list previously generated by the user. For example, in response to receiving an input of a selection of the user interface 121 object, the user computing device 120 transmits a request to access a previous user generated shopping list to the shopping list management computing system 130 via the network 140. In this example, the shopping list management computing system 130 receives the request to access a previous user generated shopping list via the network 140.

In block 430, the shopping list management computing system 130 generates a new shopping list. The new shopping list may comprise a blank shopping list without any listed items. The new shopping list may also comprise a shopping list populated with suggested product listings determined based on a past user purchase history, based on aggregated data from other users having accounts with the shopping list management computing system 130, and/or based on current advertising campaigns of the shopping list management computing system 130 or of one or more merchant computing systems (not illustrated in FIG. 1) associated with product listings in the product listings database. In response to receiving a request for a new shopping list via the network 140, the shopping list management computing system 130 transmits, to the user computing device 120 via the network 140, the new shopping list, and the user computing device 120 receives, via the network 140, the new shopping list from the shopping list management computing system 130.

In response to receiving a request to access a previous user generated shopping list by the shopping list management computing system 130 via the network 140, the shopping list management computing system 130 retrieves a requested previous shopping list previously generated by the user and stored in the data storage unit 139. The shopping list management computing system 130 may transmit, to the user computing device 120 via the network 140, the retrieved previous shopping list, and the user computing device 120 receives, via the network 140, the retrieved previous shopping list from the shopping list management computing system 130.

In block 440, the user computing device 120 displays the new shopping list via the user interface 121 of the user computing device 120.

From block 440, the method 210 proceeds to block 220 in FIG. 2. While certain functions identified in FIG. 4 are described as being performed by the shopping list management computing system 130, the functions may be performed locally by the user computing device 120. For example, the shopping list application 125 may receive the request to generate a new or previous shopping list, generate the blank shopping list (or retrieve the previous shopping list from the data storage unit 129), and render the shopping list via the user interface 121 of the user computing device 120.

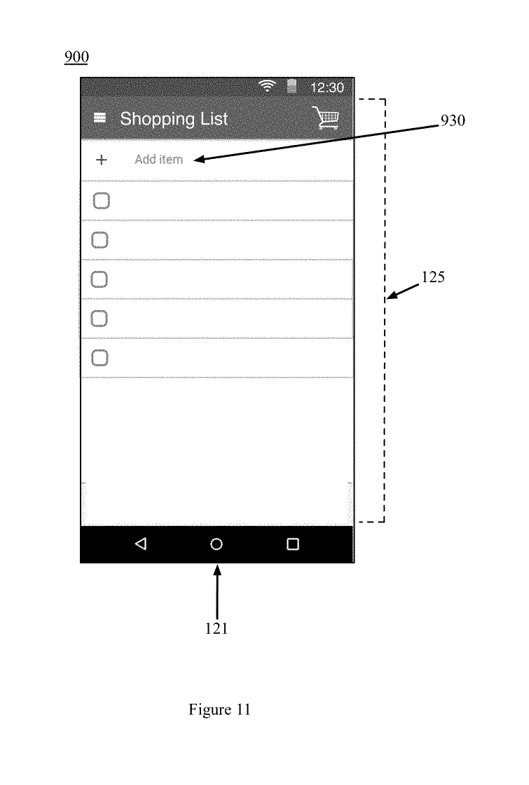

FIG. 11 is an illustration of a graphical user interface comprising an new, empty list, in accordance with certain examples. FIG. 11 depicts the new shopping list 900 displayed in the shopping list application 125 on the user interface 121 of the user computing device 120. The new shopping list 900 is displayed with empty lines. A user interface object 905 that reads “+ Add item” may be selected by the user via the user interface 121 to add a new item to the displayed shopping list.

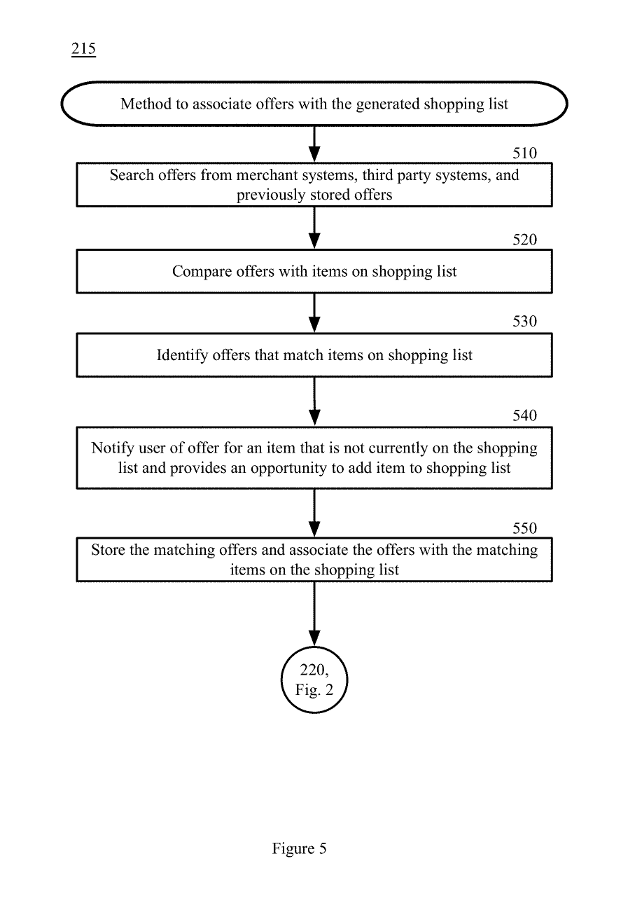

Returning to FIG. 2, in block 215, the shopping list application 125 associates offers with the generated shopping list. Block 215 will be described in further detail hereinafter with reference to FIG. 5.

In block 510, the shopping list application 125 searches for offers from offer providers 140, merchant systems, third party systems, and previously stored offers. In certain examples, certain actions performed by the shopping list application 125 in FIG. 5 may be performed by the shopping list management computing system 130 or any other suitable computing device or system. For example, offers may be searched by a third party system and provided to the shopping list application 125.

In an example, the shopping list application 125 searches offers provided by offer distribution systems. In another example, the shopping list application 125 searches offers on a merchant computing system 110 database of offers or a database of offers from another type of offer provider 150. In another example, the shopping list application 125 searches offers on a database of offers at a manufacturing computing system (not shown). In another example, the shopping list application 125 crawls or scrapes the Internet searching for offers provided by any suitable offer provider. Any other suitable source of offers may be utilized to identify offers that may be suitable for the user account associated with the shopping list.

The offers may be any suitable type of offer, such as a rebate, a discount, a “buy 1 get 1 free” offer, a loyalty points offer, or any other type of offer.

In block 520, the shopping list application 125 compares offers with items on the shopping list. In an example, when an offer is identified, such as on a database of a merchant computing system 110, the offer is compared to the items on the shopping list to determine if the offer is associated with items that the user has purchased before, included on the shopping list currently or in the past, or is currently recommended to the user. For example, if an item on the shopping list is a jar of peanut butter from a particular brand, the shopping list application 125 compares an identified offer for peanut butter to the shopping list to see if the offer matches a jar of peanut butter on the shopping list.

The shopping list application 125 provides an opportunity to the user to add the item and the associated offer to the shopping list. For example, the shopping list application 125 provides an interface object that adds the item to the shopping list when actuated by the user. In another example, the user is able to drag the item to the shopping list on the user interface of the graphical display.

In block 530, the shopping list application 125 identifies offers that match items on the shopping list. In the example, the shopping list application 125 determines that the offer for the peanut butter matches the brand, size, and type of peanut butter on the shopping list. In another example, the shopping list application 125 determines that only certain characteristics of the item on the shopping list and the offer must match. For example, if the offer is for a different size of peanut butter, then a match may still be identified. In another example, if the offer is for a different brand of peanut butter, then a match may still be identified. Any configured number or type of characteristics must match for a match of the offer and the item to be determined.

In block 540, the shopping list application 125 notifies user of offer for an item that is not currently on the shopping list and provides an opportunity to add item to shopping list. In certain examples, the shopping list application 125 recognizes and offer for a product that the user has had on the shopping list in the past, but is not currently on the shopping list. For example, if the user has updated the shopping list and has not added a certain item, such as peanut butter. The shopping list application 125 identifies an offer for a rebate on peanut butter from a particular merchant, but determines that peanut butter is not on the shopping list. The shopping list application 125 determines provides a notification to the user that item has an associated offer. The notification may be any suitable notification, such as a push notification, an email, a text message, a pop-up notification, or any other suitable notification. Alternatively, the shopping list application 125 assembles a list of items that have associated offers and provides the list to the user on the graphical display of the shopping list.

In block 550, the shopping list application 125 stores the matching offers and associates the offers with the matching items on the shopping list. When an offer is determined to match an item, the offer is stored with the item. In an example, the offer is displayed next to the item on the graphical display of the shopping list. The offer may be denoted on the graphical display in any suitable manner. For example, the offer may be indicated by a hyperlink or other object to route the user interface to a display of the entire offer. In another example, an offer icon may be displayed to indicate that an offer associated with the item is stored in an offer database. Any other indication of an associated offer may be displayed. In certain examples, an indication of the offer is not displayed. The offer is merely stored and associated with the item.

The offer is associated with the item by storing instructions to access the offer when the item is accessed. That is, when the offer is stored in a database of the shopping list application 125 or in another location, the shopping list application 125 stores instructions to redeem the offer when the item is purchased.

From block 550, the method 215 returns to block 220 of FIG. 2.

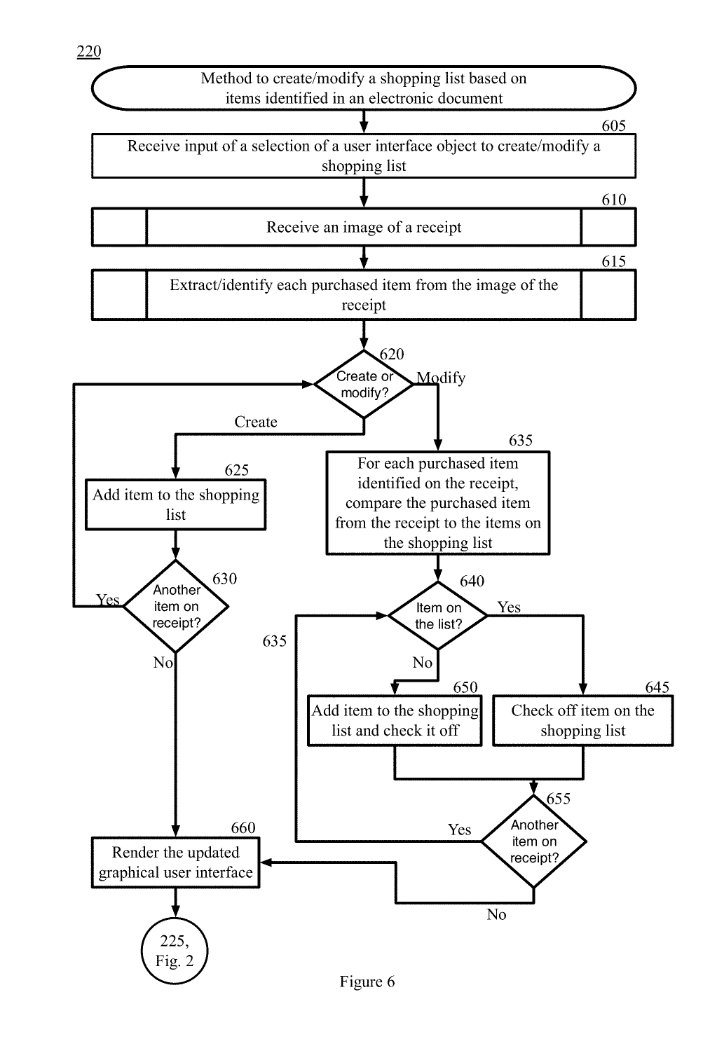

FIG. 6 is a block flow diagram depicting methods 220 to create and modify lists of items based on items identified in electronic documents, in accordance with certain examples. Methods 220 will be described with reference to the components in FIG. 1.

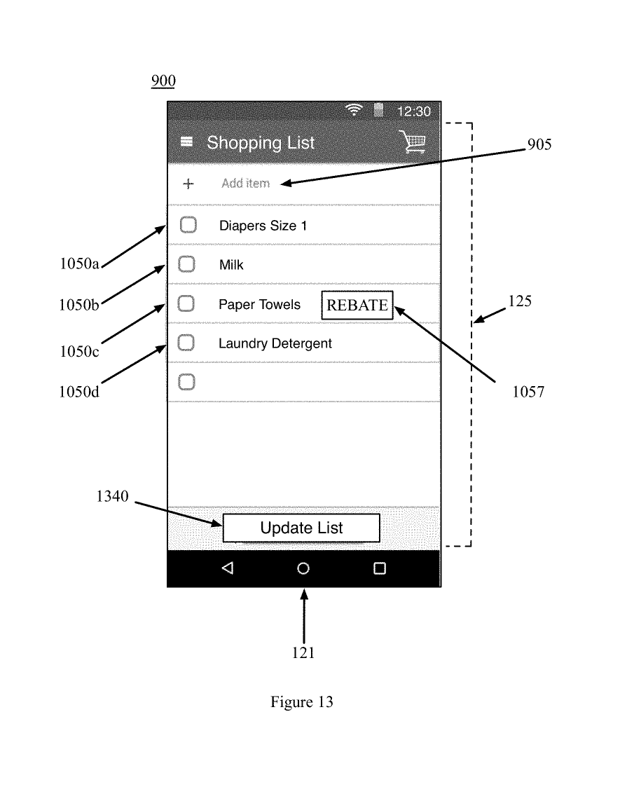

In block 605, the user selects a user interface 121 element to create or modify a shopping, and the shopping list application 125 receives the input corresponding to the user selection. For example, the user may select the “+Add Item” interface object 905 illustrated in FIG. 11 create a list by adding items to a list. Alternatively, the user may select an “Update List” interface object 1340 described hereinafter with reference to FIG. 13 to modify an existing list. Selection of a user interface object generates an input to the shopping list application to create or modify a shopping list.

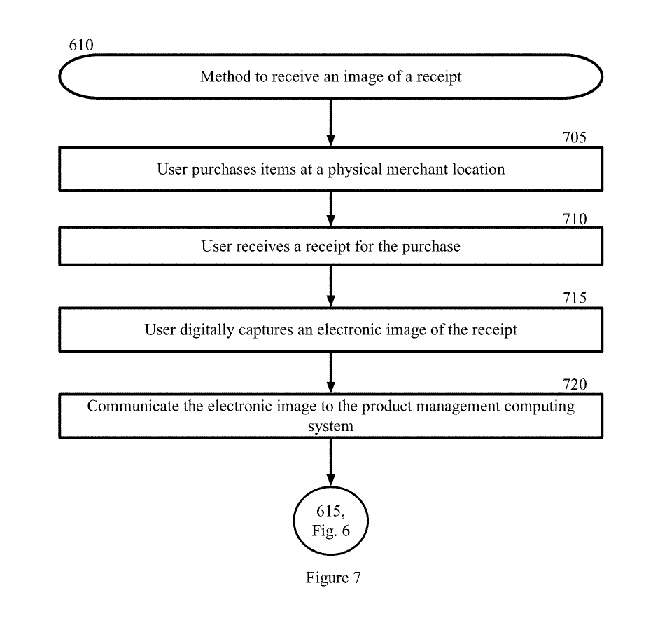

In response to receiving input to create or modify a shopping list, the shopping list application 125 prepares to receive an image of receipt in block 610. The shopping list application may activate the image capture device 124 for the user to input an image of receipt or open a file directory to allow the user to select an existing image or message, such as a word picture, word processing document, email message, or other suitable electronic document comprising a listing of items. Block 610 will be described in further detail hereinafter with reference to FIG. 7.

FIG. 7 is a block flow diagram depicting a method to receive an electronic image, in accordance with certain examples. In block 705, the user purchases one or more items at a physical merchant location. As result, in block 710, the user receives a paper receipt for the purchase.

In block 715, the user digitally captures an electronic image of the receipt. The user may use the image capture device 124 to capture the electronic image of the receipt. If the image capture device 124 is a camera, the user may take a picture of the paper receipt to capture the electronic image of the receipt. If the image capture device 124 is a scanner, the user may insert the paper receipt into the scanner to capture the electronic imaging receipt. In block 715 the user digitally captures an image of a physical receipt, such as a receipt printed on paper (or a hand-written document). The user may execute the shopping list application 125 at the user device 120 and select an icon to capture an image. In response, the shopping list application 125 activates the image capture device 124, such as a camera. The user can operate the camera to take a picture of an object or a document, such as a paper receipt documenting a purchase transaction or an electronic receipt displayed on a screen. The user may also scan a paper document, such as a paper receipt, using an external image capture device 124. The user computing device 120 stores an image file for the electronic image in the data storage unit 129 or another storage location. The user can navigate to a stored image file via the user interface 121 associated with the shopping list application 125.

The shopping list application 125 also may obtain the electronic images of receipts from electronic messages maintained by the shopping list management computing system 130. For example, the shopping list application 125 may parse electronic documents stored in the data storage unit 129 or managed by other applications on the user computing device 120 to identify receipts. When the user purchases items online or in a store, the merchant may email a receipt for other confirmation of the purchase to the user. The shopping list application 125 may recognize these electronic documents as receipts based on email addresses of the sending organization, content of the message comprising a known merchant name, and/or content of the message comprising known items available for purchase. Additionally, many electronic documents corresponding to purchases include identifying terms such as receipt, confirmation, purchase, order, or other similar terms, which identify the electronic documents as corresponding to a purchase receipt.

Although the electronic document described herein is mainly an image of a receipt, other electronic documents may provide a list of items to add to the shopping list. For example, the user may handwrite a list of items for a shopping list and capture an image of the hand-written list using the image capture device 124.

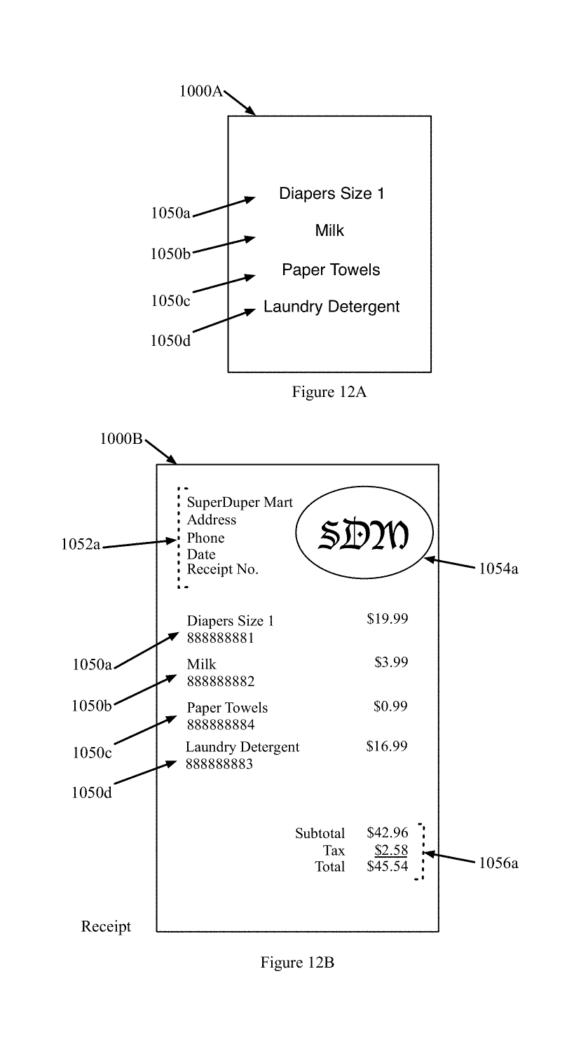

FIGS. 12A and 12B illustrate certain paper documents that serve as the source of the electronic image including items to add to a shopping list. FIG. 12A is an illustration of a hand-written list 1000A on paper, in accordance with certain examples. FIG. 12B is an illustration of a paper receipt 1000B comprising a list of items, in accordance with certain examples.

As shown in FIG. 12A, the paper list 1000A comprises a list of four items 1050a-1050d to add to the shopping list. Items 1050a, 1050b, 1050c, and 1050d read “Diapers Size 1,” “Milk,” “Paper Towels,” and “Laundry Detergent,” respectively.

As shown in FIG. 12B, the paper receipt 1000B also comprises a list of the four items 1050a-1050d to add to the shopping list. Items 1050a, 1050b, 1050c, and 1050d read

“Diapers Size 1,” “Milk,” “Paper Towels,” and “Laundry Detergent,” respectively. The paper receipt 1000B includes other information typically found on a receipt, such as merchant information 1052a (merchant name, merchant address: phone call merchant day, and receipt/order number), a merchant logo 1054a, corresponding prices associated with each of the items 1050a-1050d, and total price information 1056a (subtotal, tax, and total).

Returning to FIG. 7, in block 720, the image capture device 124 communicates the electronic image to the shopping list application 125.

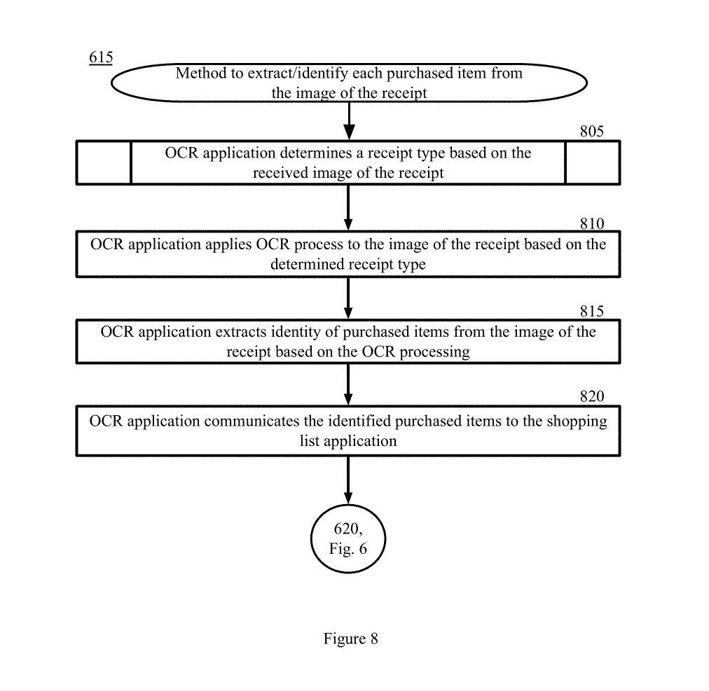

From block 720, the method 610 proceeds to block 615 in FIG. 6. Referring back to FIG. 6, in block 615, the OCR application 128 extracts and identifies each purchased item from the received image of the receipt. Block 615 will be described in further detail hereinafter with reference to FIG. 8.

FIG. 8 is a block flow diagram depicting a method 615 to extract items from electronic documents, in accordance with certain examples. The method 615 will be described with reference to the components in FIG. 1.

In block 805, the OCR application 128 determines a receipt type based on the received image of the receipt. Identifying the type of receipt allows the OCR application 128 to apply a specific OCR algorithm too specific areas of the receipt to identify items from the receipt and to avoid analyzing other information on the receipt that may not relate to the items in the purchase transaction. Block 805 will be described in further detail hereinafter with reference to FIG. 9.

FIG. 9 is a block flow diagram depicting a method 805 to determine a receipt type based on an electronic image of a receipt, in accordance with certain examples. The method 805 will be described with reference to the components depicted in FIG. 1.

In block 905, the OCR application 128 performs an image recognition algorithm on the receipt image. The image recognition may be performed by the OCR application 128 on the user computing device 120. The OCR application 128 or the shopping list application 125 may transmit the image to the shopping list management computing system 130 or another suitable computing device for the image recognition.

The OCR application 128 may use any suitable algorithm, process, method, or other manner of recognizing receipt images. For example, the OCR application 128 may isolate images, such as logo, within the image of the receipt. The OCR application 128 may apply an OCR algorithm to one or more words identified in the logo. That is, if the image recognition algorithm recognizes that a word is represented in the logo, then an OCR algorithm may be used to identify the word. For example, a logo of the receipt issuer may contain a name or other word. The employed OCR algorithm may be a function of the image recognition algorithm, a separate OCR algorithm, or other suitable OCR technique.

With reference to FIG. 12B, a receipt 1000B may include certain information. The information may include merchant information 1052a, merchant logo 1054a, product listings located in relation to the merchant information 1052a and the merchant logo 1054a, and product totals 1056a located in relation to other items on the receipt.

The OCR application 128 processes the image of the receipt and identifies logos, the merchant information, and other information on the receipt.

In block 910, the OCR application 128 compares the logo images and/or merchant information to a stored database of images/merchant information to identify matching images. The OCR application 128 identifies images, logos, words, icons, pictures, badges, and other features of the logo on the receipt image. The logo is compared to a database storing images associated with receipt issuers. The stored logo may be supplied by receipt issuers or obtained from any suitable source. For example, the stored logo may be obtained from websites associated with the receipt issuers or another suitable website. The stored logo may be supplied by a third party logo provider. Any suitable source for the logo may be used. The stored logo may be maintained in a database stored on data storage unit 129, the shopping list management computing system data storage unit 139, or another suitable computing device or data storage unit.

Similarly, the OCR application 128 compares the merchant information to a stored database of merchant data to identify matching merchants.

In block 915, the OCR application 128 identifies matches between the logo/merchant data and the stored images and merchant information in the database. For example, a particular picture in the logo may be a match to a logo in the stored images to a level of confidence over a configured confidence threshold, and/or a configurable portion of the merchant information may match merchant information stored in the database.

In block 920, the OCR application 128 extracts the identity of the logo image or merchant information from the information associated with a matching image/merchant information in the database. For example, when the OCR application 128 compares the identified logo to the database of images and locates a matching image, the OCR application 128 accesses any data stored with the matching image. Similarly, when the OCR application 128 compares the identified merchant information to the database of merchant information and locates matching merchant information, the OCR application 128 accesses any data stored with the matching merchant information. The stored data may be information about the receipt issuer, information about the issued receipt, a category of the receipt, or any suitable information.

The data stored with the matching images/information may include an identification of the receipt type. For example, the OCR application 128 may identify a logo on the receipt image that matches a logo in the database. The logo may be identified in the database as the logo for a particular merchant. In this example, the receipt image may be identified as likely being a receipt associated with the particular merchant.

In another example, the OCR application 128 may identify an image that matches an image in the database of a character associated with a particular department store, such as a cartoon mascot. In this example, the receipt image may be identified as likely being a gift receipt issued by the particular department store.

The OCR application also may determine that the receipt type is a hand-written document, such as a hand-written receipt or hand-written list, based on the writing characteristics. Writing characteristics may include the inconsistencies in ink distribution and character formation, indicating a hand-written document.

From block 920, the method 805 returns to block 810 in FIG. 8.

In block 810, the OCR application 128 applies an OCR algorithm to the receipt image to identify the information on the receipt based on the determined receipt type. The OCR application may apply a particular OCR algorithm or analyze particular portions of the receipt based on characteristics of the receipt associated with the known receipt type. If a particular receipt type is not identified, the OCR algorithm applies a standard process to the receipt.

The OCR algorithm may represent any suitable process, program, method, or other manner of recognizing the digits or characters represented on the receipt image. The accuracy and speed of the OCR algorithm may be improved by using the information obtained in the image recognition process. For example, the OCR application may have determined that a logo or merchant information on the receipt image matches a logo or merchant information associated with a particular merchant. An OCR algorithm may be used that is customized for receipts from the particular merchant. The OCR algorithm may be customized to look for characters in particular locations on the receipt image to identify the listed products. The OCR algorithm may be customized to look for a certain number of characters. The OCR algorithm may be customized to look for certain combinations of characters, such an SKU. The OCR algorithm may be customized to know that the receipts from the particular merchant typically have certain data on the reverse side of the receipt. The OCR algorithm may be customized to look for any configured arrangements, data locations, limitations, receipt types, character configurations, or other suitable data associated with the particular receipt type.

In block 815, the OCR application 128 extracts the receipt information, such as the products listed on the image of the receipt. Other information, such as the merchant information, may also be extracted from the image.

The OCR application 128 extracts the relevant information from the receipt image. The OCR application 128 displays the extracted data on the user interface 121 to allow the user 101 to verify or edit the data.

In block 820, the OCR application 128 communicates the identified items from the receipt to the shopping list application 125.

From block 820, the method 615 proceeds to block 620 in FIG. 6.

Returning to FIG. 6, the method 220 proceeds to block 620. In block 620, the method 215 determines whether the user input an action to create or modify a list. For example, if the user selected the add item user interface object, the method 220 determines that the user wants to create a list by adding items to a list. In this case, the method 220 branches to block 625.

In block 625, the shopping list application 125 adds an item to the shopping list. Referring to FIGS. 12A and 12B, the receipts 1000A and 1000B each included a list of four items 1050a-1050d to add to the shopping list. Items 1050a, 1050b, 1050c, and 1050d read “Diapers Size 1,” “Milk,” “Paper Towels,” and “Laundry Detergent,” respectively. Accordingly, if processing either receipt 1000A or 1000B, the shopping list application 125 parses the information received in block 510 to identify the first item 1050a on the receipt, add that item to the list, and then determines in block 530 whether more items exist to be added to the list. If so, the method 220 repeats block 625 and block 630 until all items are added to the list. In this manner, the shopping list application 125 will add all four items 1050a-1050d to the list.

The method 220 then proceeds to block 660 in which the shopping list application 125 renders the shopping list on the user interface 121 of the user computing device 120.

FIG. 13 is an illustration of a graphical user interface comprising a shopping list 900 including items created based on items identified in an electronic document, in accordance with certain examples. As depicted in FIG. 13, the list 900 displays all four items 1050a-1050d. FIG. 13 depicts the new shopping list 900 displayed in the shopping list application 125 on the user interface 121 of the user computing device 120. The new shopping list 900 is displayed with the four items 1050a-1050d and additional empty lines. The user interface object 905 that reads “+Add item” may be selected by the user via the user interface 121 to add more new items to the displayed shopping list. Additionally, a user interface object 1340 that reads “Update List” is presented and may be selected by the user via the user interface 121 to update the items in the displayed shopping list.

As illustrated on FIG. 13, an indication that an offer 1057 has been associated with an item 1050c is displayed. As described in FIG. 4, the offer 1057 has been identified from a third party source or from a set of stored offers and has been associated with the item 1050c. In this example, a rebate has been associated with the paper towels. When the user purchases paper towels under conditions that match the requirements of the rebate, then the rebate will be applied.

Referring back to block 620, if the shopping list application 125 determines that the user desires to modify an existing list, the method 220 branches to block 635. For example, if the shopping list application 125 receives an input indicating a selection of the update list user interface object 1340, the shopping list application 125 determines to update an existing list. In this case, the method 220 branches to block 635.

In block 635, for each purchased item identified on the receipt, the shopping list application 125 compares the purchased item from the receipt to the items on the shopping list to determine, in block 640, whether any purchased items on the receipt are already on the shopping list.

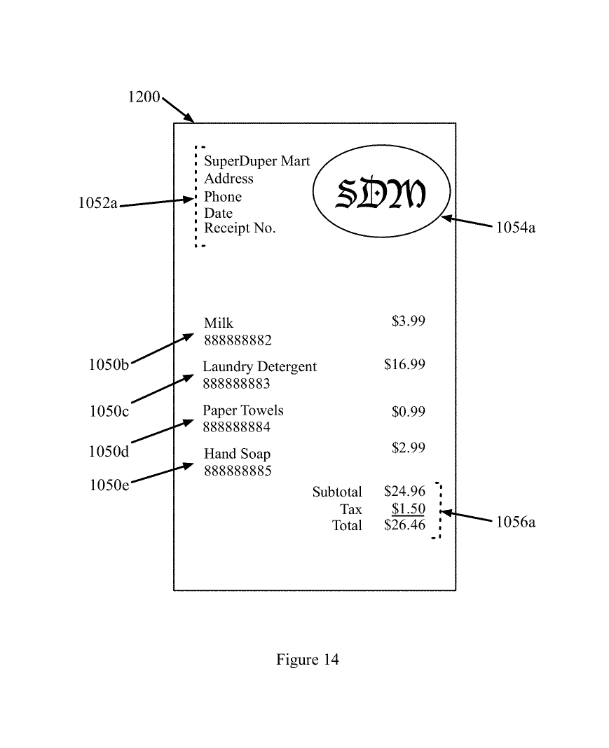

FIG. 14 is an illustration of another electronic document 1200 comprising a list of items in a receipt, in accordance with certain examples. The document 1200 may be an image of a paper receipt or a received electronic receipt. Any other electronic document may be utilized. As an example, consider that the receipt 1200 is a receipt for items purchased after creation of the list 900 and has been processed through blocks 510 and 515 to identify items on the receipt 1200. The receipt 1200 includes a listing of four items 1050b-1050e. Items 1050b, 1050c, 1050d, and 1050e read “Milk,” “Paper Towels,” “Laundry Detergent,” and “Hand Soap,” respectively. Accordingly, when comparing the items listed in the receipt 1200 with the items on the list 1100 from FIG. 13, the shopping list application 125 determines that items 1050b-1050d for milk, paper towels, and laundry detergent from the receipt 1200 already exist on the shopping list 1100. In this case, the method 215 branches to block 645, in which the shopping list application checks off the items 1050b-1050d for milk, paper towels, and laundry detergent on the shopping list.

The receipt 1200 also includes item 1050e for hand soap, which was not on the previous shopping list 1100. Accordingly, with reference to blocks 635 and 640, when comparing the items listed in the receipt 1200 with the items on the list 900 from FIG. 13, the shopping list application 125 determines that item 1050e for hand soap from the receipt 1200 did not already exist on the shopping list 1100. In this case, the method 220 branches to block 650, in which the shopping list application adds item 1050e for hand soap to the list and also checks off item 1050e for hand soap.

Via block 655, the shopping list application 125 repeat blocks 635, 640 and 645, 650 until it has processed each item from the receipt 1200. The method 220 then proceeds to block 660 in which the shopping list application 125 renders the updated shopping list on the user interface 121 of the user computing device 120.

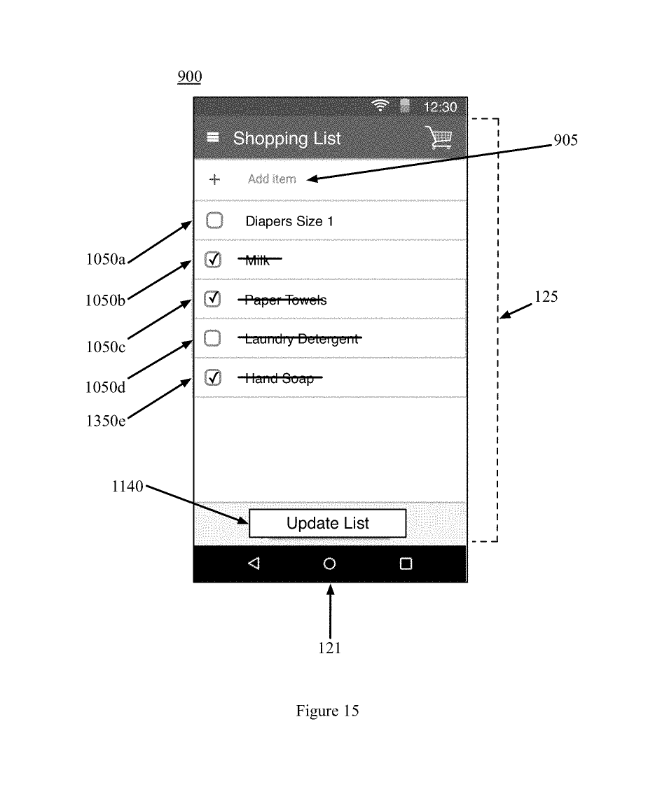

FIG. 15 is an illustration of a graphical user interface comprising a shopping list 900 of items modified based on items identified in an electronic document, in accordance with certain examples. FIG. 15 depicts the updated shopping list 900 displayed in the shopping list application 125 on the user interface 121 of the user computing device 120. As depicted in FIG. 15, the list 900 displays all four items 1050a-1050d previously listed on the list 900 in FIG. 13. However, because items 1050b-1050d were determined to exist on the subsequent receipt 1200, the list 900 depicts items 1050b-1050d as “checked-off” to indicate that those items are not needed. The check-off depiction can be any suitable indication that the items on the list have been obtained or are otherwise not on the list. As depicted in FIG. 15, the check-off is indicated with a check mark, strikethrough of the item, or a combination. The check-off also could be indicated by moving those items to another section of the list denoted to indicate those items have been removed from the list. Additionally, these items could be deleted entirely from the list.

The list 900 also displays the new item 1050e for hand soap, which was identified on the subsequent receipt 1200 but not on the previous list 110. The item 1050e is added and then indicated as checked off. In this manner the shopping list application 125 may aggregate a more accurate purchase history for the user account associate with the shopping list. In the user interface displaying the list 1300, the user interface object 905 that reads “+ Add item” may be selected by the user via the user interface 121 to add more new items to the displayed shopping list. Additionally, the user interface object 1140 that reads “Update List” is presented and may be selected by the user via the user interface 121 to further update the items in the displayed shopping list.

From block 660, the method 220 returns to block 225 of FIG. 2. In block 220 of FIG. 2, the shopping list application 125 redeems a stored offer based on receipt data.

In block 1005, the shopping list application 125 compares purchased items identified in the receipt to the stored offers in the shopping list. When the shopping list application 125 identifies items on the receipt, the shopping list application 125 identifies items from the shopping list that have been updated based on the receipt data to show as purchased. The shopping list application 125 compares the identified updated items on the shopping list to determine which items have associated offers. In another example, the shopping list application 125 compares the items directly from the receipt data to identify. That is, the shopping list application 125 identifies items on the receipt data and directly compares the item identification to the stored offers. In another example, the shopping list application 125 compares the identified items to offers that are not stored. That is, the shopping list application 125 searches through third party sources or databases for offers that match the identified product.

In block 1010, the shopping list application 125 determines if the purchase meets the requirements of the stored offer. The shopping list application 125 identifies the characteristics of the purchase transaction, such as the date and time of the transaction, the exact model number of the item, the merchant system that sold the item, price paid for the item, or any other transaction characteristics. In certain examples, only a portion of this data is extracted from the receipt either because the extraction was not completed successfully or the receipt did not include all of the data. For example, a receipt may not include the entire model number of an item, but only a portion of the model number.

The shopping list application 125 compares the available extracted data to the requirements of the offer. For example, the offer may require that a purchase be made before a certain expiration date. The shopping list application 125 may compare the date of the transaction that is extracted from the receipt to the expiration date of the offer. Any of the features of the extracted data and the offer requirements may be compared to determine if the transaction qualifies based on the terms of the offer.

If the purchase meets the requirements of the offer, then the transaction is determined to qualify for the offer. In certain examples, all of the requirements must be met. For example, each of the identify of the item purchased, the identity of the merchant system, and the date of the transaction must all be met before the transaction is determined to qualify for the offer.

The shopping list application 125 uses the image of the receipt as a proof of purchase or other evidence to support the redemption of the offer. If the offer provider requires evidence to prove that the terms of the offer are met, the shopping list application 125 may provide all or a portion of the digital image of the receipt as evidence. For example, the shopping list application 125 may email or otherwise transmit the image to the offer provider 140 to verify that the data is accurate. For example, the receipt can be used to verify the date of the transaction, the model number of the item purchased, the merchant system selling the product, or any other required data.

In box 1015, the shopping list application 125 redeems the offer by submitting the transaction to the offer provider 150 for redemption. In an example, the offer is a rebate of $5 when the transaction is over $50. If the terms of the offer are met, then the product management computing system 130 submits the details of the transaction to the offer provider. If the offer provider 150 approves the rebate, then the offer provider may transmit $5 to the user by sending funds to the shopping list application 125, to an issuer computing system, to a bank account of the user, to the user via a check, or in any other suitable manner. If the offer provider 150 determines that the transaction does not meet the terms of the offer, then the rebate is refused. In another example, the offer provider 150 may provide a quantity of loyalty points or rewards to the user based on the terms of the offer. Any other suitable action may be taken by the offer provider based on the terms of the offer and the item purchased.

In box 1020, the shopping list application 125 indicates on the shopping list that an offer has been redeemed for the item on the shopping list. For example, the graphical representation of the shopping list may show a checkmark or other indication that an offer has been redeemed. In another example, the graphical representation of the shopping list displays the amount of the offer redeemed or discounted, such as “$5.00 saved.” In another example, the graphical representation of the shopping list merely removes the indication that an offer is associated with this item on the shopping list. Any other suitable indication that an offer has been redeemed may be utilized.

### Other Example Embodiments

FIG. 16 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to modify graphical user interfaces based on new data obtained from electronic documents, comprising:
receiving, by one or more computing devices, a first digital image comprising a first set of data;
extracting, by the one or more computing devices, the first set of data from the first digital image;
populating, by the one or more computing devices, a list with the first set of data;
receiving, by the one or more computing devices, a second digital image comprising a second set of data;
extracting, by the one or more computing devices, the second set of data from the second digital image;
modifying, by the one or more computing devices, the list based on the second set of data.

2. The computer-implemented method of claim 1, further comprising removing, by the one or more computing devices, a particular item from the list when the particular item is extracted from the second set of data.

3. The computer-implemented method of claim 1, further comprising searching, by the one or more computing devices, a set of third party data to identify content items that are relevant to a particular item on the list.

4. The computer-implemented method of claim 3, further comprising associating, by the one or more computing devices, data from the set of third party data with the particular item on the list.

5. The computer-implemented method of claim 4, further comprising applying, by the one or more computing devices, the data from the set of third party data based on the association.

6. The computer-implemented method of claim 1, wherein modifying the list further comprises:
comparing, by the one or more computing devices, one or more particular items on the populated list to one or more particular items in the extracted second set of data;
identifying, by the one or more computing devices, a particular item that is on both the populated list and the extracted second set of data; and
removing, by the one or more computing devices, the particular item from the list.

7. The computer-implemented method of claim 1, further comprising receiving, by the one or more computing devices, an input from a user interface to generate the list.

8. The computer-implemented method of claim 1, wherein the first and second digital images are received from a camera module of the one or more computing devices.

9. The computer-implemented method of claim 1, wherein the list is a shopping list of items a user intends to purchase.

10. The computer-implemented method of claim 1, wherein the second digital image is obtained from a paper receipt.

11. The computer-implemented method of claim 1, wherein the second digital image is obtained from a digital receipt.

12. A computer program product, comprising:
a non-transitory computer-readable storage device having computer-executable program instructions embodied thereon that when executed by a computer cause the computer to modify graphical user interfaces based on new data obtained from electronic documents, the computer-executable program instructions comprising:
computer-executable program instructions to populate a list with a first set of data;
computer-executable program instructions to receive a second digital image comprising a second set of data;
computer-executable program instructions to extract second set of data from the second digital image;
computer-executable program instructions to modify the list based on the second set of data.

13. The computer program product of claim 12, further comprising:
computer-executable program instructions to receive a first digital image comprising the first set of data; and
computer-executable program instructions to extract the first set of data from the first digital image.

14. The computer program product of claim 12, further comprising computer-executable program instructions to remove a particular item from the list when the particular item is extracted from the second set of data.

15. The computer program product of claim 12, further comprising computer-executable program instructions to receive an input from a user interface to generate the list.

16. The computer program product of claim 12, further comprising computer-executable program instructions to search a set of third party data to identify content items that are relevant to a particular item on the list.

17. The computer program product of claim 16, further comprising computer-executable program instructions to associate data from the set of third party data with the particular item on the list.

18. A system to select payment accounts to modify graphical user interfaces based on new data obtained from electronic documents, comprising:
a storage device; and
a processor communicatively coupled to the storage device, wherein the processor executes application code instructions that are stored in the storage device to cause the system to:
populate a list with a first set of data;
receive a second digital image comprising a second set of data;
extract the second set of data from the second digital image;
modify the list based on the second set of data.

19. The system of claim 18, wherein the processor further executes application code instruction to:
compare one or more particular items on the populated list to one or more particular items in the extracted second set of data;
identify a particular item that is on both the populated list and the extracted second set of data; and
remove the particular item from the list.

20. The system of claim 18, wherein the first and second digital images are received from a camera module of the one or more computing devices.
